(19) United States
(12) Patent Application Publication
(10) Pub. No.: US 2014/0292009 A1
(43) Pub. Date: Oct. 2, 2014

(54) Digging and Tilling Implements with Knee Clearance

(71) Applicants: Andrew John Hudson, Santa Rosa, CA (US); Caralin Riva Adair, Santa Rosa, CA (US)

(72) Inventors: Andrew John Hudson, Santa Rosa, CA (US); Caralin Riva Adair, Santa Rosa, CA (US)

(21) Appl. No.: 14/231,188

(22) Filed: Mar. 31, 2014

Related U.S. Application Data
(60) Provisional application No. 61/807,076, filed on Apr. 1, 2013.

(51) Int. Cl. A01B 1/02; A01D 9/00

(52) U.S. Cl. CPC A01B 1/02; A01D 9/00
USPC 294/55.5; 294/60

(57) ABSTRACT

Digging and tilling tools with both a central step and an offset shaft are disclosed. The central step allows a user to apply pressure directly over the centerline of the tool head, and the shaft, offset to one side, allows clearance for the knee. The handle on the other end of the shaft may be offset in line with the centerline of the tool head. In some embodiments, the offset shaft may be connected with the tool head by means of connecting members which connect between the shaft and sides of the tool head, leaving a central opening and acting as “stirrups” or guides for the user's foot. In addition to the horizontal offset of the shaft, the tool head may be rearwardly offset from the shaft. Also disclosed are tool heads with tines having L- and T-shaped cross-sections.

### CROSS-REFERENCE TO RELATED APPLICATIONS

This application claims priority to U.S. Provisional Application No. 61/807,076, filed Apr. 1, 2013, which is incorporated by reference in its entirety.

### BACKGROUND OF THE INVENTION

1. Field of the Invention

In general, the invention relates to tools, and in particular to digging and tilling implements with knee clearance.

2. Description of Related Art

The common spading fork allows the user to leverage body strength to till soil. The user applies force through his foot to drive the fork into the soil, and then pulls back with both hands to drive the tines upward, loosening the soil. The same action is used with digging or trenching shovels, and other tools.

Although functional, there is a flaw in this common design. The tool shaft is in line with the centerline of the tool head. Therefore the foot of the user is offset from the centerline of the tool head. Consequently the user applies force to the tool head offset from the resultant of the resistance forces acting on the tines, and the tool tends to rotate sideways. This tendency to rotate sideways may be counteracted by the user applying sideways force at the handle to maintain correct orientation of the tool, but often the tool may still rotate enough to cause the foot of the user to slip off the tool.

A number of inventions have addressed the difficulty in foot placement found in conventional shovels. U.S. Pat. No. 5,401,071 to Tummino (1995) and U.S. patent application publication 2006/0170231 to Brown (2006) describe tools with increased foot support areas, but these areas are not in line with the centerline of the tool head. U.S. Pat. No. 5,503,445 to Fontaine (1996) describes a foot support area that is in line with the centerline of the tool head, but this area is behind the central shaft, leaving minimal actual clearance for the foot of the user.

Numerous inventions describe applying force with the foot to a spading fork or shovel in line with the centerline of the tool head, with clearance for the foot of the user. U.S. Pat. No. 294,587 to Cowdery (1884), U.S. Pat. No. 3,226,149 to McJohnson (1965), U.S. Pat. No. 7,121,599 to Demar (2006), U.S. Pat. No. 5,871,058 to Naccarato (1999), U.S. Pat. No. 4,904,011 to Hawk (1990), U.S. Pat. No. 821,847 to Arnavat (1906), U.S. Pat. No. 2,956,831 to Duppengiesser (1960), and U.S. Pat. No. 5,645,305 to Lispi (1997) all describe tools with a central step. Similarly, U.S. design Pat. No. D198,979 to Petoe (1964), U.S. design Pat. No. D526,864 to Braun (2006), and U.S. design Pat. No. D662,387 to Key (2012) claim ornamental designs of tools with central steps.

However, these references fail to provide clearance for the knee of the user to the tool shaft. It has been found that when using a spading fork with a central step and shaft in line with the centerline of the tool, the knee of the user strikes the shaft, making it difficult or impossible to use efficiently. This shortcoming is exaggerated in the case of a trenching operation, where there is limited room for the shovel handle and the knee and leg of the user.

Additional problems with spading forks arise from the shape of their tines. The traditional spading fork has a cross-section that transitions from generally rectangular toward the top of the tool head to a generally pentagonal cross-section with a pointed tip at the leading edge of the tool. This cross-section does enable the traditional spading fork to disturb soil, and it does resist side loads that may be generated if the tine encounters a rock. However, the traditional tine shape and cross-section do not handle bending loads effectively, which can cause bent or broken tines.

U.S. Pat. No. 3,781,053 to Wicks (1973) and U.S. Pat. No. 2,406,175 to Talley (1946) describe a spading fork with tines with a deep cross-section designed to resist the bending loads generated during spading, with the conventional minimal cross-sectional area. In addition, Wicks describes a sharp leading edge. Unfortunately, these designs fail to adequately resist side loads, and fail to generate adequate soil disturbance for loosening compacted soil.

### SUMMARY OF THE INVENTION

One aspect of the invention relates to a digging or tilling tool. The tool has a tool head, a shaft connected to the tool head at a position horizontally offset from a centerline of the tool head, and a central step or platform on or connected to the tool head. The central step or platform allows a user to apply force directly over the center of the tool head, while the offset shaft allows for knee clearance. The tool handle, connected to the other end of the shaft, may be offset such that it is in line with the centerline of the tool head.

In some embodiments, a male or female first engaging structure, like a socket or a spike, may be connected to the tool head by means of two connecting members which connect to the tool head proximate to its side edges, leaving an open space between them. The first engaging structure is offset horizontally from the centerline of the tool head, such that the user can apply pressure directly over the centerline of the tool head, and the two connecting members act as a “stirrup” or guides that guide a user's foot. In some cases, particularly where a deep-digging tool is desired, a second platform or step may be defined between the two connecting members, spaced vertically from the first platform or step on the tool head. In these and other embodiments, the tool head may also be rearwardly offset from the shaft.

Another aspect of the invention relates to digging and tilling tool heads and tools with tines have L- or T-shaped cross-sections. These cross-sections may allow for more efficiency in entering and moving soil, greater resistance to bending loads, and ultimately, fewer bent and broken tines.

These and other aspects, features, and advantages of the invention will be set forth in the description that follows.

### BRIEF DESCRIPTION OF THE DRAWING FIGURES

The invention will be described with respect to the following drawing figures, in which like numerals represent like features throughout the drawings, and in which:

FIGS. 1a to 1c are perspective, front elevational, and cross-sectional views, respectively, of a spading fork with a central step and offset shaft constructed in accordance with one embodiment of the invention;

FIG. 2a is a cross-sectional view of a spading fork tine in accordance with one embodiment of the invention;

FIG. 2b is a cross-sectional view of a spading fork tine in accordance with another embodiment of the invention;

FIGS. 3a and 3b are perspective and side elevational views, respectively of a similar spading fork with a central step and offset shaft constructed in accordance with another embodiment of the invention;

FIGS. 4a to 4c are perspective, exploded perspective, and front elevational views, respectively, of a similar spading fork with a central step and offset shaft constructed in accordance with yet another embodiment of the invention;

FIGS. 5a to 5c are perspective, front elevational, and side elevational views, respectively, of a spading fork with two central steps and offset handle in accordance with another embodiment of the invention;

FIGS. 6a and 6b are perspective and elevational views of a spading fork with a central step and curved offset shaft in accordance with another embodiment of the invention;

FIGS. 7a and 7b are perspective and elevational views of a spading fork with a central step and curved offset shaft with a different handle;

FIGS. 8a and 8b are perspective and elevational views of a shovel with a central step and offset shaft constructed in accordance with another embodiment of the invention;

FIGS. 9a and 9b are perspective and elevational views of a similar shovel with a central step and offset shaft constructed in accordance with another embodiment of the invention;

FIGS. 10a and 10b are perspective and elevational views illustrating the forces acting on a shovel with a central step, offset shaft, and an L shaped handle constructed in accordance with another embodiment of the invention;

FIG. 11 is an elevational view illustrating the forces acting on a spading fork with a central step, offset shaft, and an L shaped handle constructed in accordance with another embodiment of the invention;

FIGS. 12a and 12b are perspective and exploded perspective views of a shovel with a central step and offset shaft constructed in accordance with another embodiment;

FIGS. 13a and 13b are perspective and elevational views of a conventional spading fork head with a central step adapter constructed in accordance with another embodiment;

FIGS. 14a and 14b are perspective and elevational views of a conventional shovel head with a central step adapter constructed in accordance with another embodiment; and

FIGS. 15a and 15b are perspective and elevational views of a prior art spading fork head with a central step adapter constructed in accordance with another embodiment.

### DETAILED DESCRIPTION

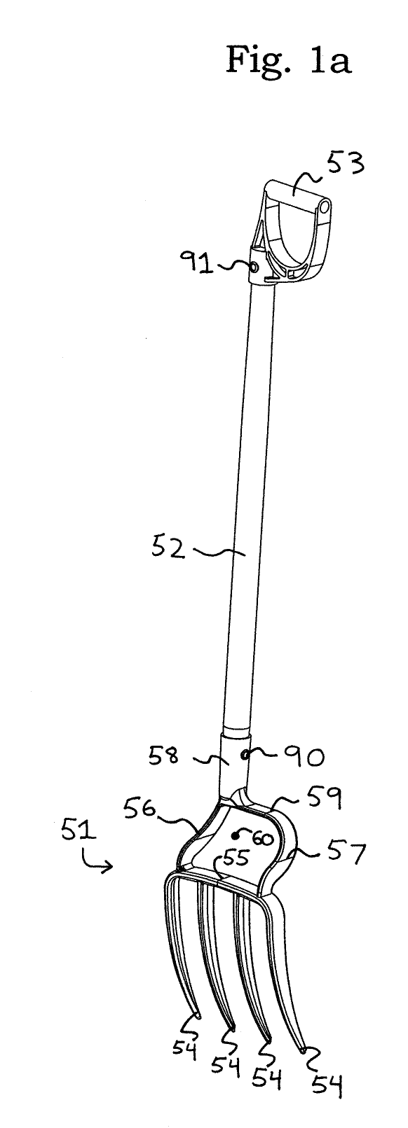

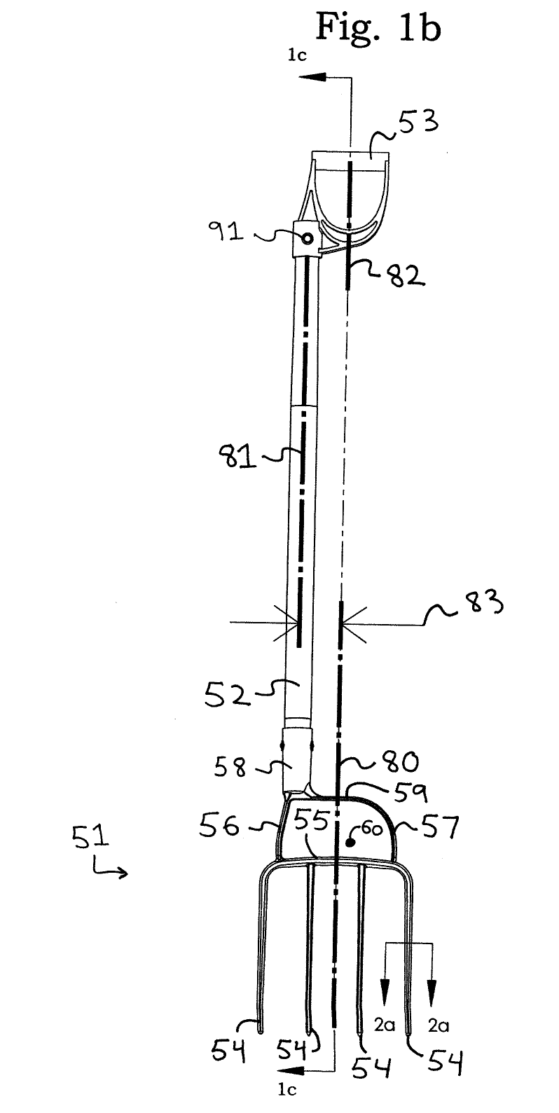

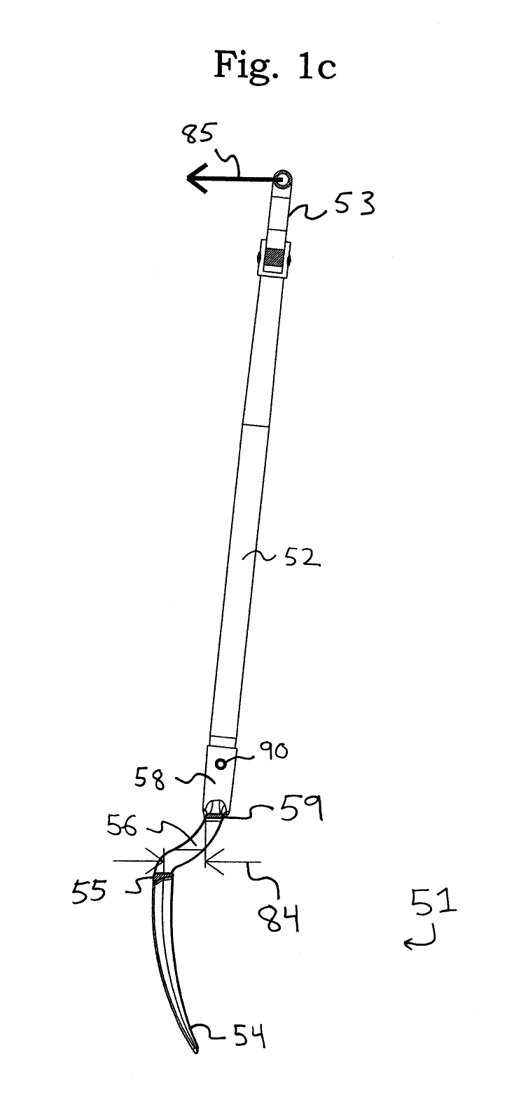

One embodiment is illustrated in FIG. 1a (perspective view), FIG. b (rear elevational view), and FIG. 1c (cross-sectional view). In FIG. 1a, a spading fork includes a tool head 51 attached to a shaft 52 that is attached to a handle 53. Handle 53 may be injection-molded thermoplastic, such as polypropylene, or one of many other materials and/or fabrication processes providing adequate strength and stiffness. Head 51 may be fabricated by a variety of methods from a wide variety of materials, although this embodiment has been designed to be cast. It may be cast in a variety of metals, with a wide variety of ferrous and non-ferrous alloys providing satisfactory properties. Head 51 is comprised of a plurality of tines 54 attached to a horizontal member, cross bar, or central step 55 that allows the user's foot to be placed directly over tines 54 while the tool is driven into the soil. Head 51 incorporates two support sections, a left support 56 and a right support 57, that support a socket 58. A rivet 90 attaches socket 58 to shaft 52. A variety of means may be used to attach socket 58 to shaft 52, and the advantages of the embodiment are independent of the means of attachment. In particular, the attaching structure on the tool head 51 may be either male or female, with a complementary engaging structure on or attached to the shaft 52. A section of right support 57 curves to meet left support 56, forming a horizontal or nearly horizontal section 59. A stirrup-like opening or aperture 60 created by the divergence of supports 56 and 57 allows the placement of the user's foot directly on central step 55. A second rivet 91 attaches shaft 52 to handle 53. Once again, a variety of means may used to attach shaft 52 to handle 53, and the advantages of the embodiment are independent of the means of attachment.

FIG. 1b shows an offset 83 between a tool head centerline 80 and a shaft centerline 81. Offset 83 is large enough to allow the knee of the user to remain directly over head centerline 80 without interfering with shaft 52. Furthermore, a handle centerline 82 may also be offset from shaft centerline 81, and may coincide with head centerline 80 as shown here, to avoid generating twisting torque about head centerline 80 during the loosening of soil. Supports 56 and 57 transfer forces from shaft 52 to tines 54, either directly or through central step 55. Additionally, horizontal section 59 may be used to lift the tool with the foot.

FIG. 1c illustrates that horizontal section 59 is positioned in front of central step 55 by a forward offset 84. (In other words, the tool head 51 is rearward of or below the shaft 52.) In this position, forward offset 84 may prevent or reduce the risk of discomfort or injury to the user's foot as the handle 53 is rotated between vertical and horizontal to lift and move soil. The forward offset 84 is an optional feature, but it is advantageous in most embodiments. In some embodiments, the offset 84 may be on the order of about 3.5 inches (9 cm).

The size of any particular tool head 51 may vary from embodiment to embodiment, depending on the job the tool is intended to perform, the nature of the materials of which it is made, and other factors. The width of the central step 55 may vary with the overall width of the tool head 51. Preferably, the central step 55 and, when one is present, the opening 60, will be wide enough to accommodate an average work boot. For example, in one embodiment, the tool head 51 may be approximately 8 inches (20 cm) in width. In that case, the central step 55 may be at least about 5 inches (13 cm) in width, and preferably between 5.5 and 6 inches (14 cm and 15 cm).

The tool head 51 of FIGS. 1a-1c and other tined tools according to embodiments of the invention may use the kind of traditionally-shaped tines described above. However, the present inventors have found that particular tine shapes and cross-sections may increase the efficiency of the tool head 51 and its ability to resist bending loads.

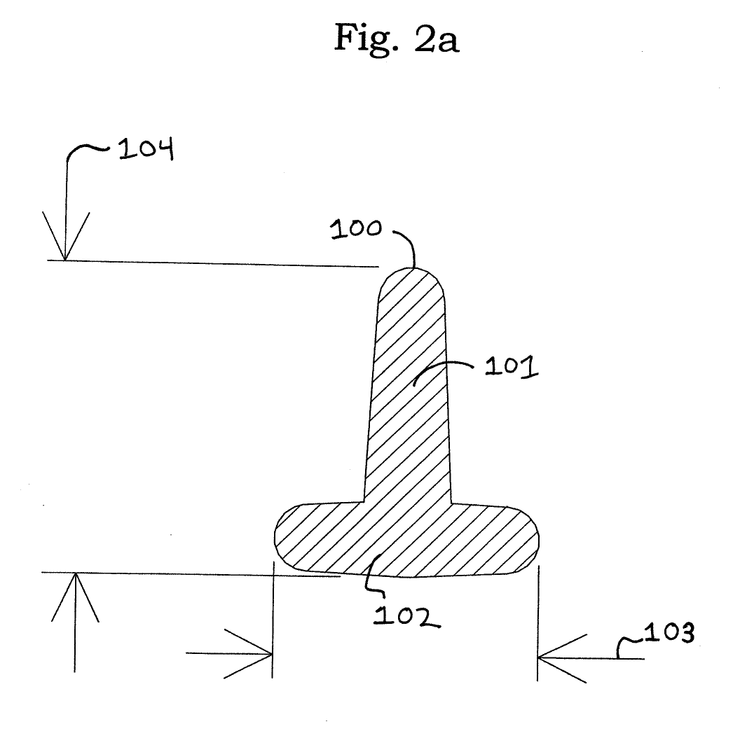

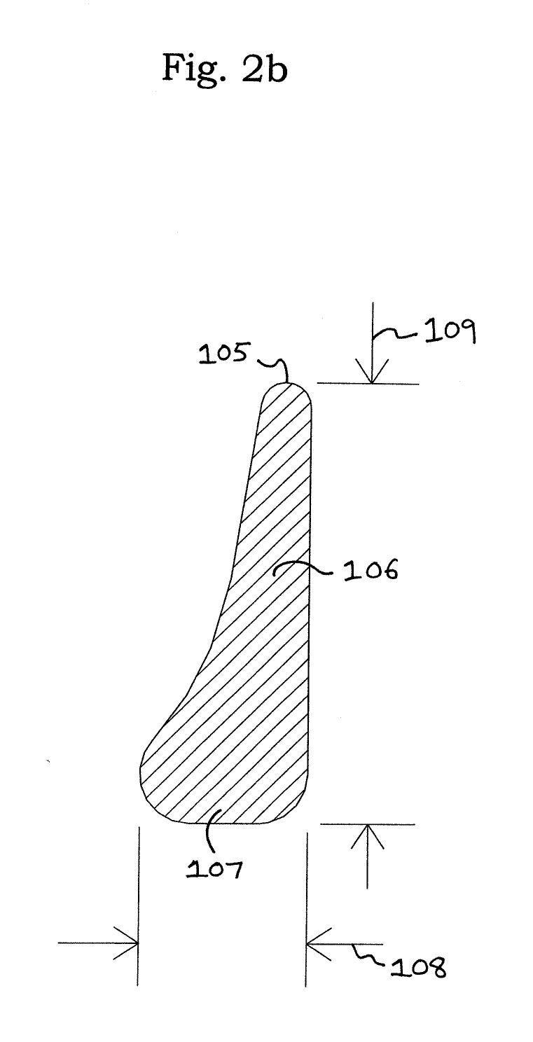

Two embodiments of tine cross-sections are illustrated in FIG. 2a and FIG. 2b. FIG. 2a shows the cross-section of tine 54. As shown, the tine 54 has an inverted T-shape, with the long portion of the T forming a forwardly-extending front rib 101 that terminates in a leading edge 100. The leading edge 100 may be rounded as shown, or it may be sharpened to a point to improve the ability of the fork to cut through roots. The front rib 101 has a sufficient depth 104 to add bending resistance to the tine. A back rib 102, the cross-member of the T, has a sufficient width 103 to resist the movement of the tine through the soil, ensuring adequate tilling of the soil. The width 103 also helps the tine resist side-loads that may act on it during soil penetration, tilling or general handling of the tool.

FIG. 2b shows a similarly advantageous tine cross-section, which, in this case, is an L-shape. The long member of the L serves as a front rib 106, which terminates in a leading edge 105. The leading edge 105 may be rounded as shown, or it may be sharpened to a point to improve the ability to cut through roots. A front rib 106 has a sufficient depth 109 to add bending resistance to the tine. A back rib 107 has a sufficient width 108 to ensure adequate tilling of the soil and resist side-loads. In both embodiments, by forming the tine cross-section in a T-shape or L-shape, the area of the cross-section is minimized, reducing the soil-penetration effort required.

In FIGS. 2a and 2b, the aspect ratios of the cross sections, i.e., the height of the front rib 100, 106 divided by the width of the back rib 102, 107 would generally be in the range of 1.25 to 2.0. As will also be appreciated from the figures, the cross sections of the illustrated embodiments have fillet radii, i.e., the transitions between the respective front ribs 100, 106 and the back ribs 102, 107 are curved, instead of being 90° angles. Depending on the method by which the tines are manufactured and other factors, 90° angles without fillet radii may be used in some embodiments.

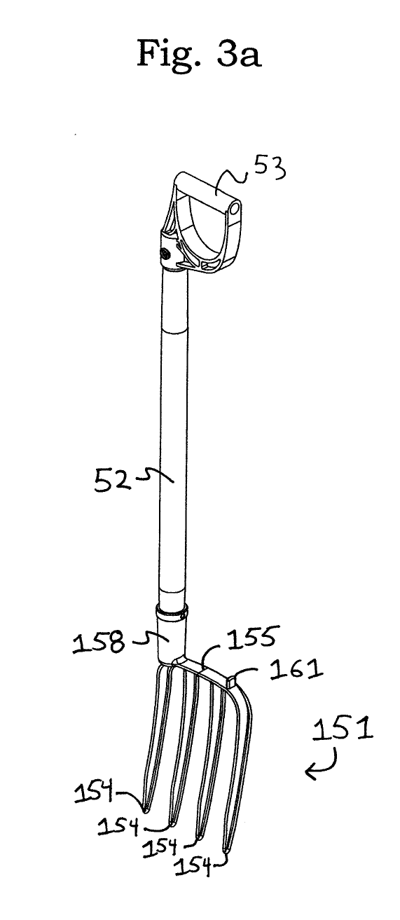

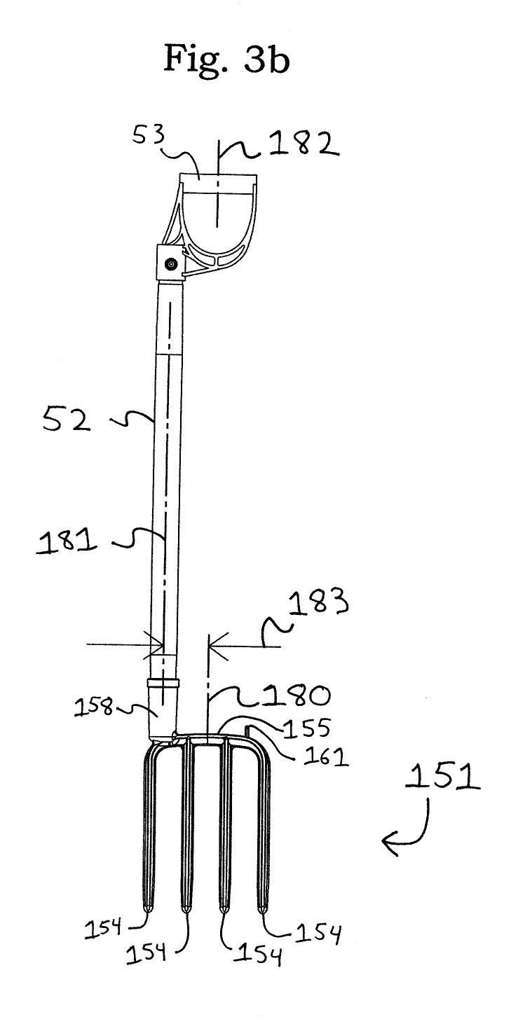

FIGS. 3a and 3b show a second embodiment of a spading fork. In FIG. 3a, shaft 52 attaches to a tool head 151 via a socket 158 or other means of attachment. Head 151 may be fabricated by a variety of methods from a wide variety of materials, although this embodiment has been designed to be cast. A central step 155 acts as a structural cross bar to transfer the loads from the shaft to a plurality of tines 154. The foot of the user may be placed at the center of head 151 on central step 155 without interference with shaft 52 and the leg and/or knee of the user. A guide 161 serves to prevent the foot of the user from slipping sideways off central step 155.

In FIG. 3b, an offset 183 of a shaft centerline 181 from a tool head centerline 180 allows the knee and leg of the user to remain centered over tool head 151 during operation without interfering with shaft 52. In this embodiment, a handle centerline 182 is offset to align with a head centerline 180. This alignment is not necessary to realize most of the benefits of this embodiment, although it is advantageous in that it reduces bending and twisting moments.

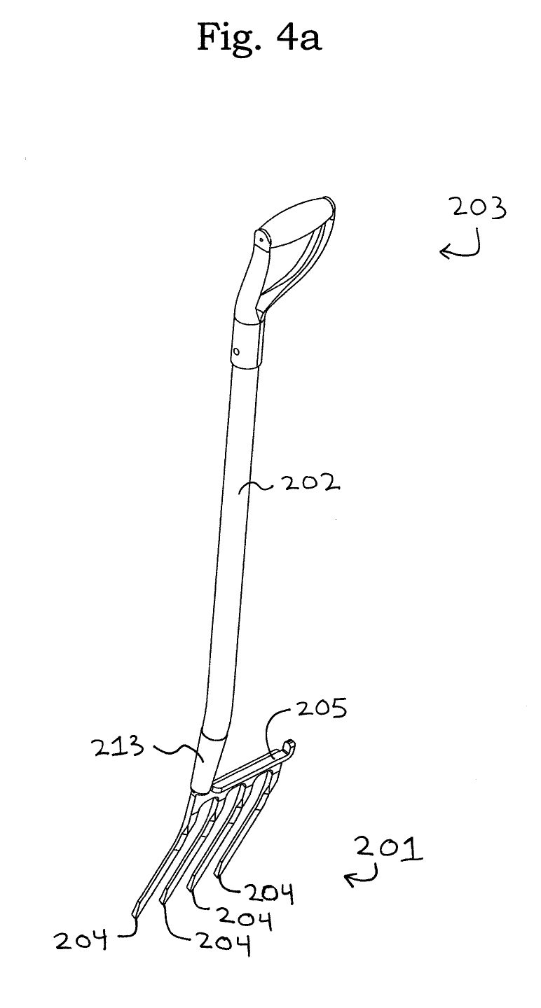

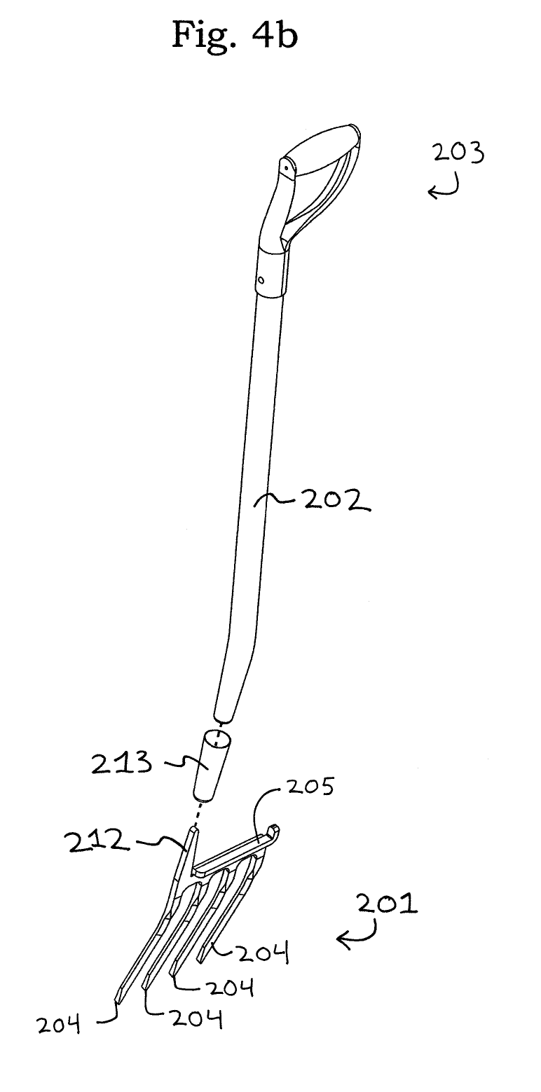

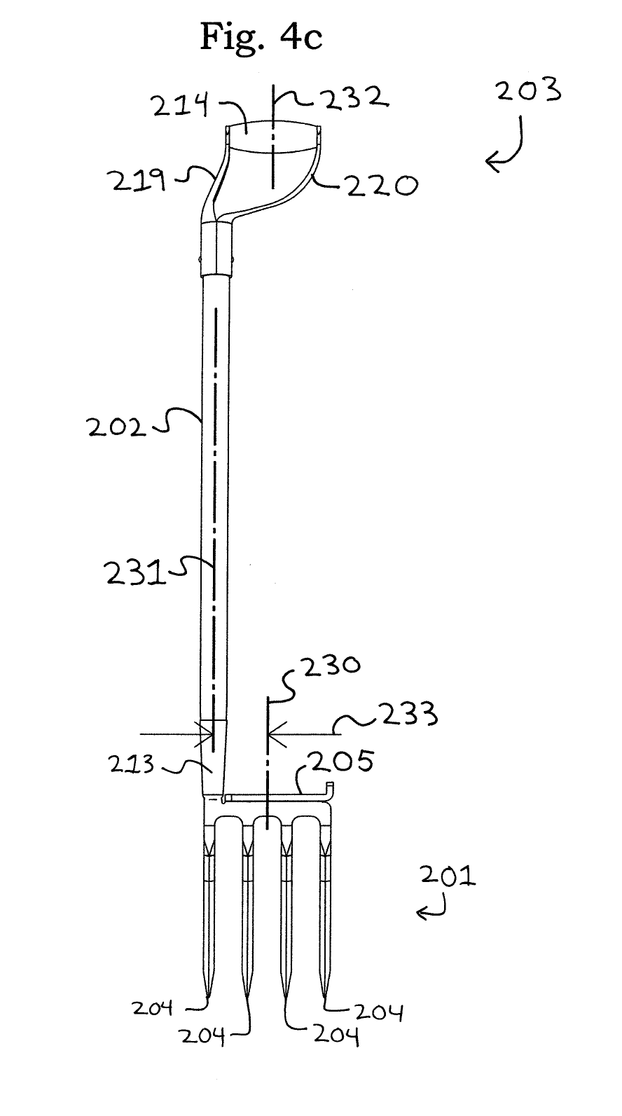

A third embodiment is illustrated in FIGS. 4a (perspective view), 4b (exploded view), and 4c (rear elevational view). FIG. 4a shows a tool head 201 designed to be fabricated by forging, stamping or other methods commonly used in fabrication with flat metal stock. Tool steels would be well suited to this application, although other ferrous and non-ferrous alloys would also be suitable. A plurality of tines 204 may be forged to match either cross-section shown in FIG. 2a or FIG. 2b, or may match the cross-section of conventional spading forks.

FIG. 4b shows that head 201 attaches to a shaft 202 through a spike 212 that is forced into the end of shaft 202 and gripped by a ferrule 213 in a manner commonly used in commercially available spading forks.

FIG. 4c shows an offset 233 of a shaft centerline 231 from a tool head centerline 230 that allows the user to apply force to a central step 205 without interference between the leg and knee of the user and shaft 202. Shaft 202 may be curved (not shown) to locate a handle 203 in the optimal location for the user. In this embodiment, handle 203 includes a left stamped metal member 219 and a right stamped metal member 220 supporting a wooden grip 214. Handle 203 could also be manufactured from any other combination of materials, or may be made as a single piece of metal, plastic or other suitable material. In addition, handle 53 and handle 203 are equally applicable to this application. A handle centerline 232 may be aligned with a head centerline 230.

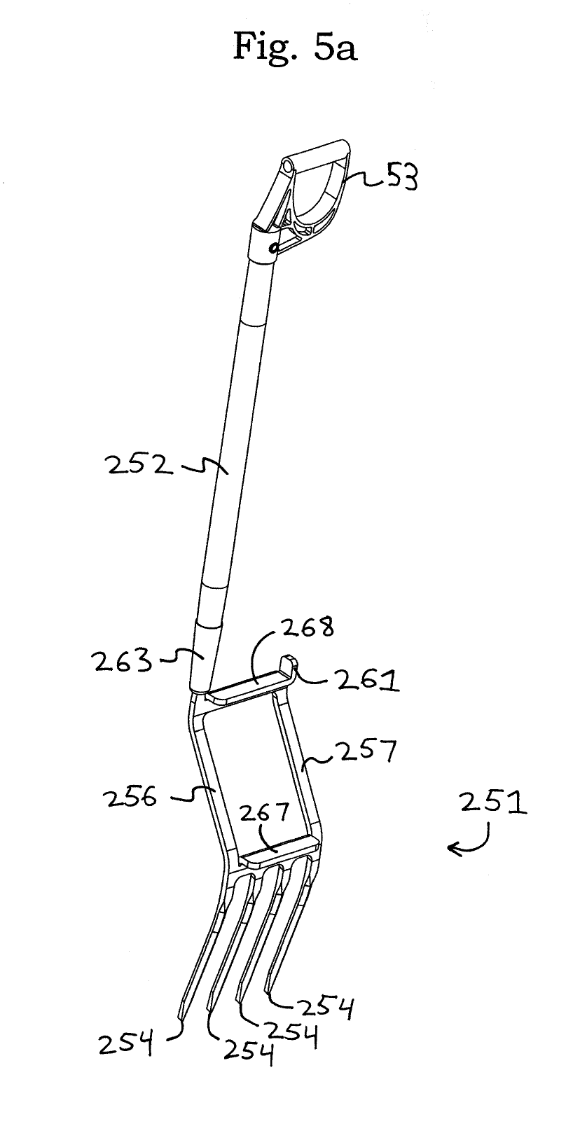

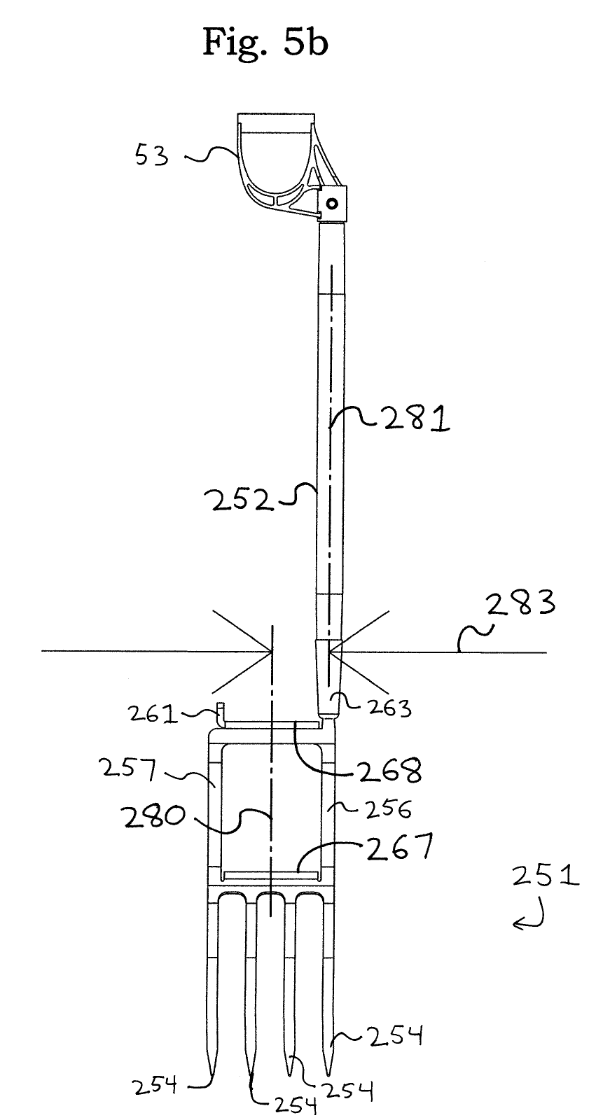

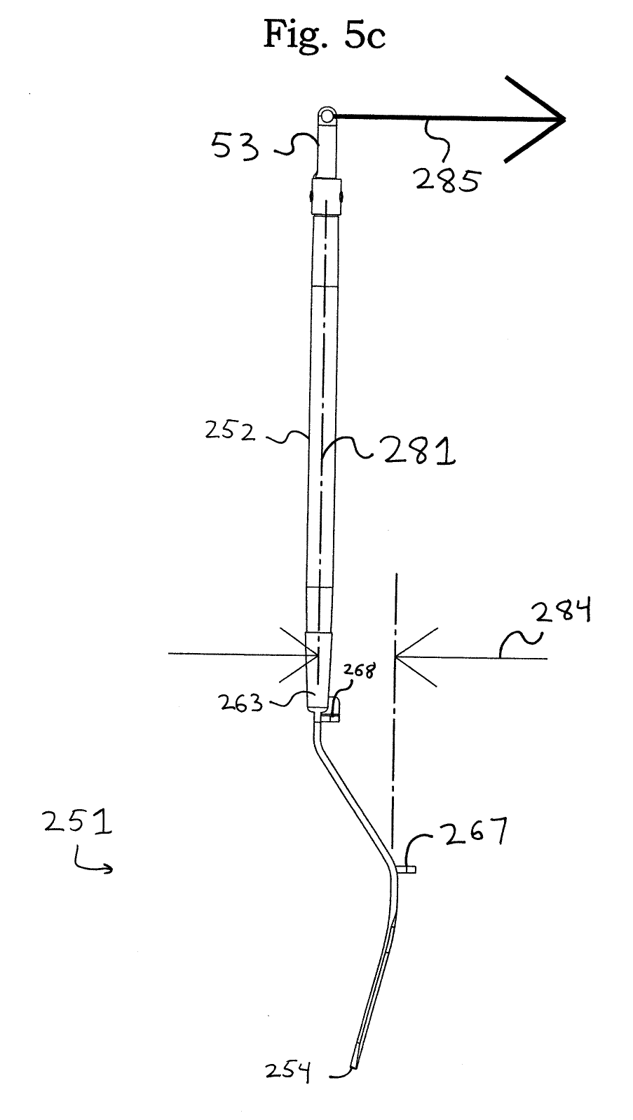

FIGS. 5a, 5b, and 5c illustrate an embodiment of a deep-digging garden tool. In FIG. 5a (perspective view), a tool head 251 is attached to a shaft 252 that is attached to handle 53. Head 251 comprises a plurality of step surfaces, with two shown here as lower central step 267 and upper central step 268. Upper step 268 allows the user leverage to drive the tool into the ground below the soil surface level, thus allowing more efficient deep-digging The process of double digging, used extensively in biodynamic gardening, can be simplified with the use of a tool such as this one. A left support 256 and a right support 257 connect a plurality of tines 254 and lower step 267 to upper step 268 and a connecting ferrule 263, and also act as guides for the user's foot when lower step 267 is utilized. A guide 261, in the form of an upwardly curved end of the upper step 268, may be incorporated into upper step 268 to keep the user's foot from slipping off. This embodiment may be constructed in an equivalent manner to the embodiment shown in FIG. 4b.

FIG. 5b (rear elevational view) shows an offset 283 of a shaft centerline 281 from a tool head centerline 280 that allows the user to apply force to either lower step 267 or upper step 268 without interference between the leg and knee of the user and shaft 252. As with the offset 83, this may prevent discomfort or injury to the foot when the shaft 252 is rotated between vertical and horizontal.

FIG. 5c (side view), illustrates a forward offset 284 of a shaft centerline 281 from lower step 267. During use, handle 53 may be pulled back in the direction shown by an arrow 285 to a nearly horizontal position. In this position, forward offset 284 prevents discomfort or injury to the user's foot.

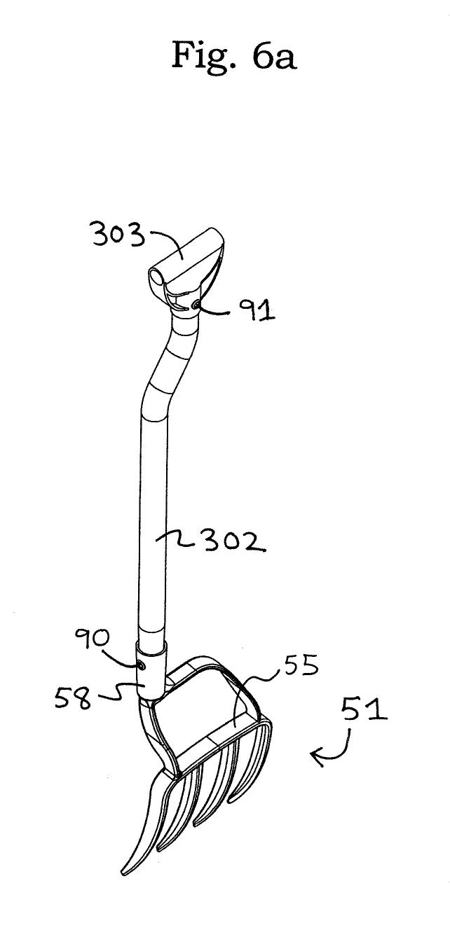

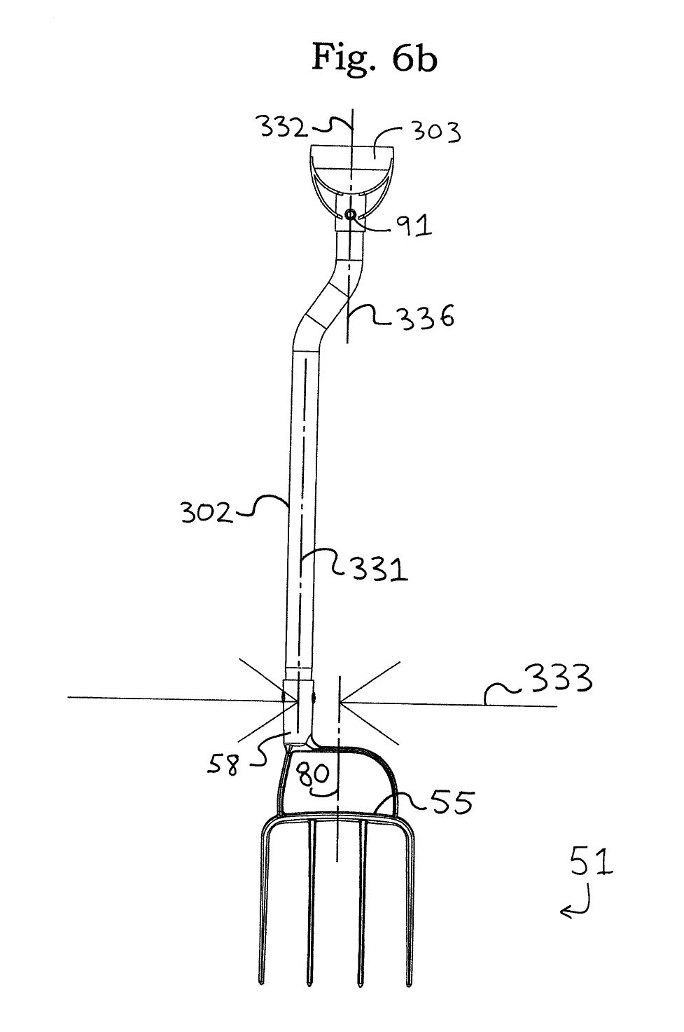

FIG. 6a shows an embodiment in which head 51 is attached to a curved shaft 302 that is attached to a handle 303. Rivet 90 attaches socket 58 to shaft 302. Handle 303 is connected to shaft 302 with rivet 91 or other appropriate means.

FIG. 6b, the rear elevational view of the embodiment of FIG. 6a, illustrates an offset 333 of a lower shaft centerline 331 from tool head centerline 80 that allows the user to apply forces to central step 55 without interference between the leg and knee of the user and shaft 302. FIG. 6b also shows an upper shaft centerline 336 and a handle centerline 332 aligned with tool head centerline 80. Curved shaft 302 could be curved in a variety of ways other than the geometry shown and would still realize the benefits of the embodiment.

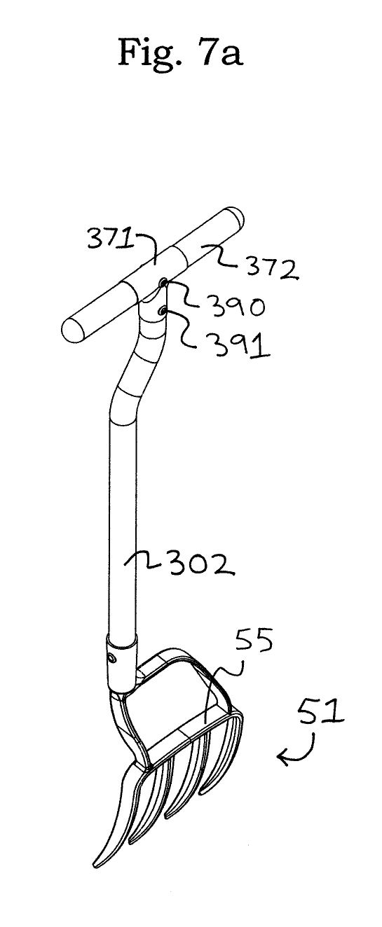

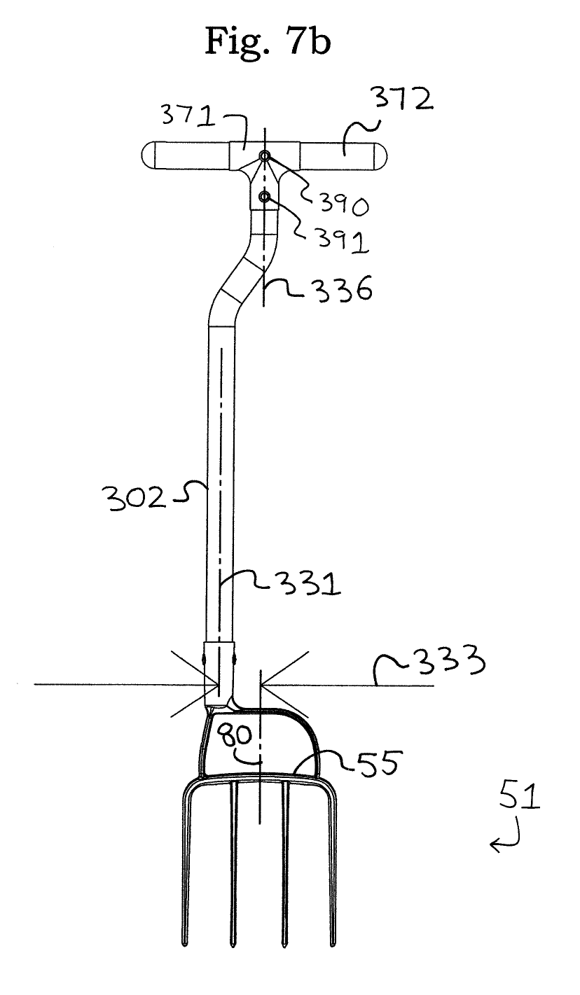

FIG. 7a shows an embodiment in which head 51 is attached to curved shaft 302 with an alternate handle. A Tee connector 371 attaches to shaft 302 with a rivet 391. A handle bar 372 attaches to tee connector 371 with a rivet 390. Handle bar 372 is perpendicular to shaft 302 so that tilling forces may be applied by the user with both hands. This gives an advantage to users with reduced hand or arm strength in applying tilling forces to the handle.

FIG. 7b, the rear elevational view of the embodiment of FIG. 7a, again illustrates offset 333 of lower shaft centerline 331 from tool head centerline 80 that allows the user to apply forces to central step 55 without interference between the leg and knee of the user and shaft 302. Furthermore FIG. 7b depicts the alignment of upper shaft centerline 336 with tool head centerline 80, and shows the symmetry of handle bar 372 about tool head centerline 80, which eliminates the tendency of the tool to twist about head centerline 80 as handle bar 372 is pulled back towards the user.

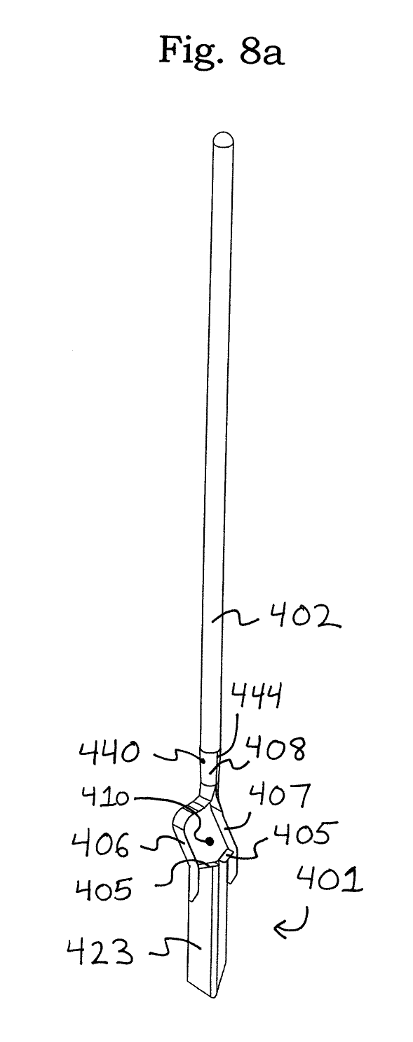

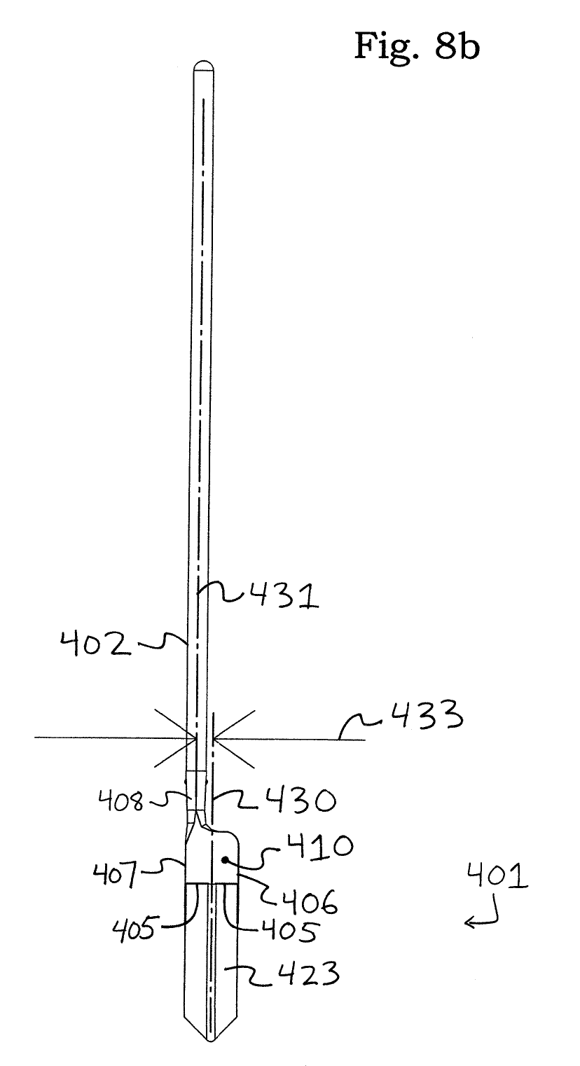

FIG. 8a (perspective view) and FIG. 8b (rear elevational view) depict a shovel embodiment comprising a tool head 401 connected to a shaft 402 via a rivet 440 or other means. This particular embodiment, having a narrow and deep shovel blade 423, is best suited for the task of excavating a narrow trench, such as one used for burying sprinkler lines or electrical conduit. Shovel blade 423 is attached to a socket 408 through a right support 407 and a left support 406. Socket 408 may be welded along a weld line 444. One or more central steps 405 are formed at the top of blade 423 to allow the user to push the shovel blade into the soil, while pushing directly through the center of tool head 401.

FIG. 8b shows an aperture 410 formed by right support 406 and left support 407. Aperture 410 makes room for the user to place her foot on step surfaces 405 at the top of blade 423, directly in line with a blade centerline 430. It is desirable to offset shaft 402 as far as possible to one side while avoiding excessive overhang outside the width of the blade, maximize efficiency in trench digging. By creating offset 433 of a shaft centerline 431 from blade centerline 430, space is made available to allow the user to maneuver her leg to one side of the shovel while pushing the blade into the soil at the bottom of a trench.

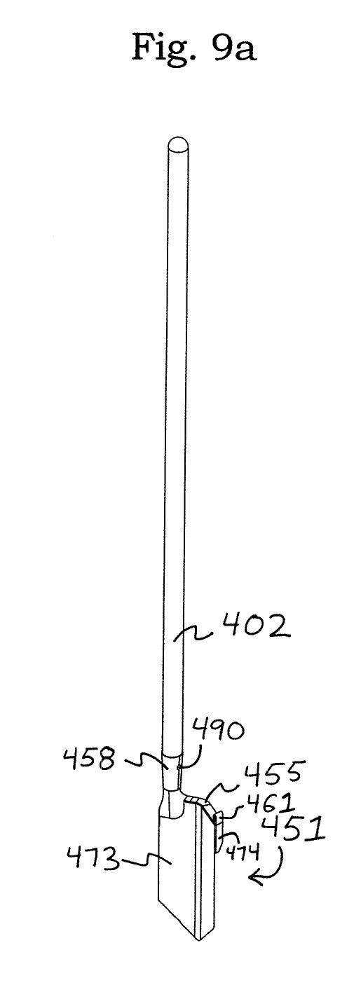

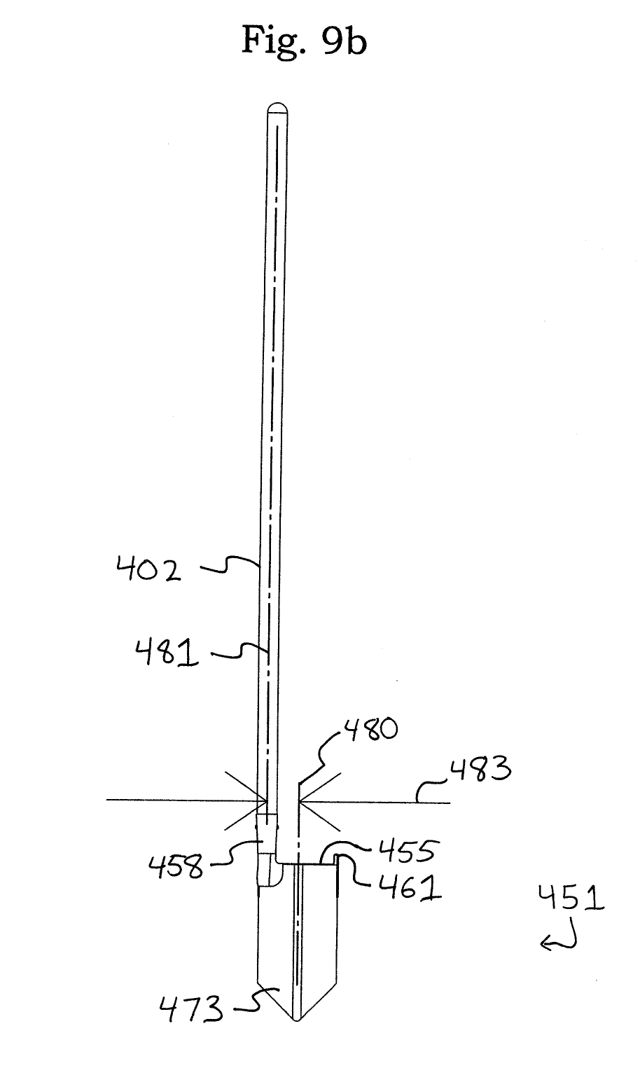

FIG. 9a (perspective view) and FIG. 9b (rear elevational view) depict another shovel embodiment, comprising a tool head 451 attached to a shaft 402 via a socket 458 and a rivet 490, or other connection method. A central step 455 of head 451 are oriented approximately perpendicular to a shovel blade 473 and provide an optimal surface to which foot pressure can be applied to drive shovel blade 473 into the ground. Head 451 also includes a guide 461 to prevent the user's foot from sliding off the step during use, and a side tab 474 to increase rigidity of blade 473, but these two features are not required. Head 451 may be formed from one or more pieces of sheet tool steel, or other materials with an appropriate combination of stiffness, strength, etc, and may have a different blade shape than the one illustrated here. Head 451 may be formed out of a single piece of sheet metal, or by fastening multiple pieces of metal through welding, riveting, using threaded fasteners, or other means of joining the pieces into a rigid unit.

FIG. 9b shows an offset 483 of a shaft centerline 481 relative to a blade centerline 480, which allows unimpeded access for the user's foot to apply pressure to central step 455 at the top of blade 473, without encountering interference between the knee or leg of the user and shaft 402. Additionally, the location of guide 461 is depicted on the opposite side of head centerline 480 from socket 458.

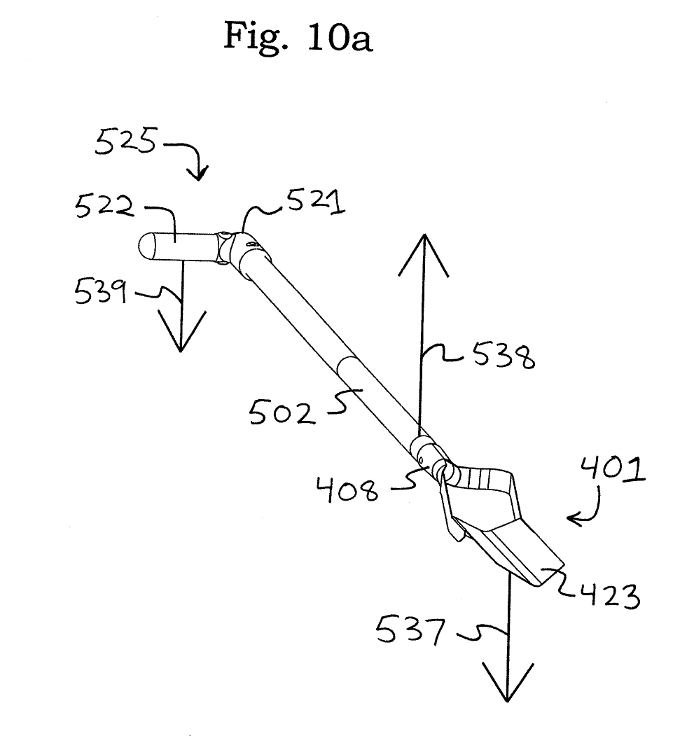

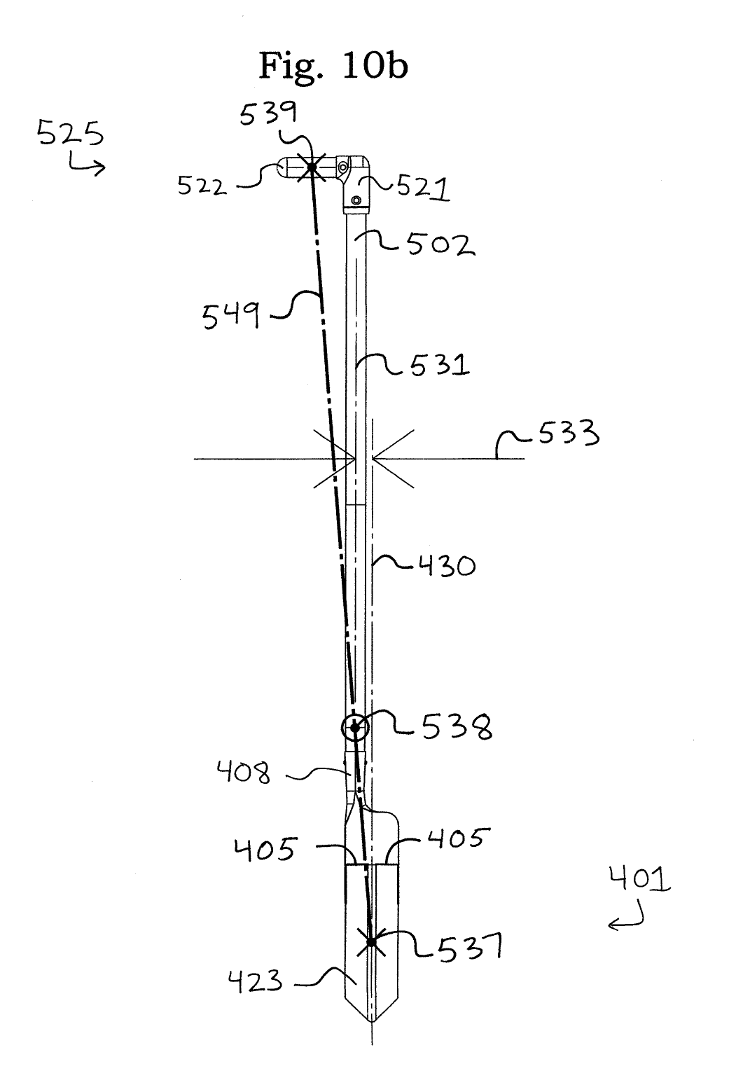

Head 401 is shown with a different shaft/handle configuration in FIG. 10a (perspective view) and in FIG. 10b (front view). A shaft 502 is connected to an L-shaped handle 525 via a right angle fitting 521. A grip 522 is oriented approximately perpendicular to shaft 502 and extends out from shaft 502 away from head centerline 430 as is best seen in FIG. 10b.

FIG. 10a illustrates the forces acting on the shovel when it is being used to transport a load of soil or other material. The weight of the soil acts as a single payload force 537 approximately through the center of blade 423. The user holds shaft 502 near socket 408, and lifts with a lift force 538. The shovel is balanced by the application of a balance force 539 applied by the user to grip 522.

The alignment of these forces is best shown in FIG. 10b. Payload force 537 is illustrated as an X, lift force 538 is shown as a circle, and balance force 539 is shown as an X. It can be demonstrated that the shovel will not tend to twist in the hand of the user if the shovel is designed to align these three forces on a straight line 549. Furthermore FIG. 10b shows an offset 533 of a shaft centerline 531 from a blade centerline 430 that allows the user to apply forces to central step surfaces 405 without interference between the leg and knee of the user and shaft 502.

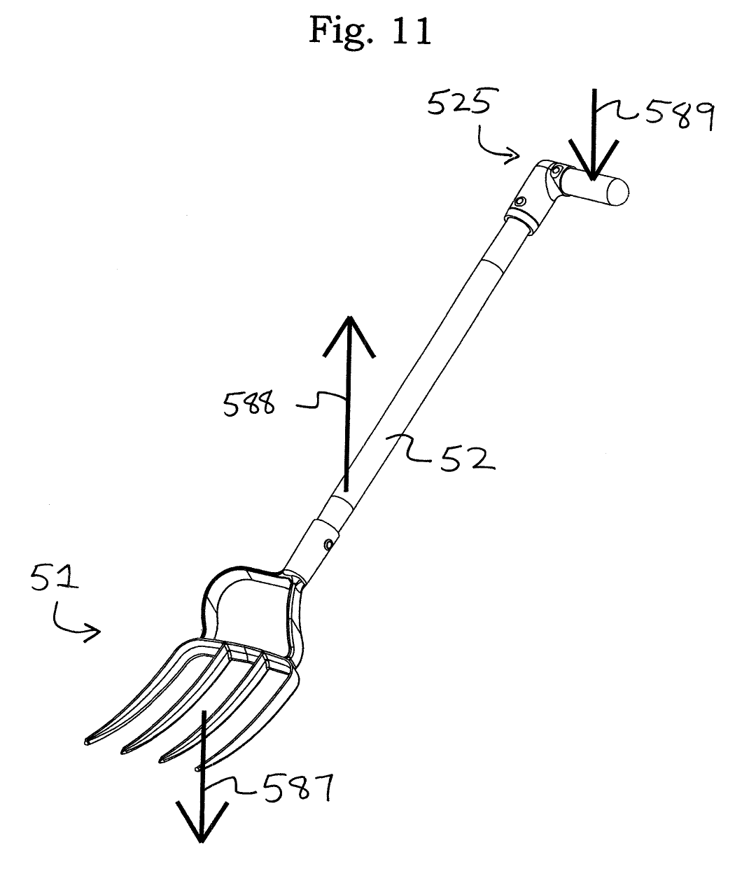

FIG. 11 portrays a spading fork with head 51 and shaft 52 with L-shaped handle 525. In some soil conditions, it is necessary to break up clumps of soil by lifting them up off the ground and bouncing the clumps on the tines of the spading fork until they are broken into small pieces. In this case the loads on the fork, namely a payload force 587, a lift force 588, and a balance force 589, are identical to a shovel being used to move soil as depicted in FIGS. 10a and 10b, in which case the embodiment depicted in FIG. 11 is advantageous.

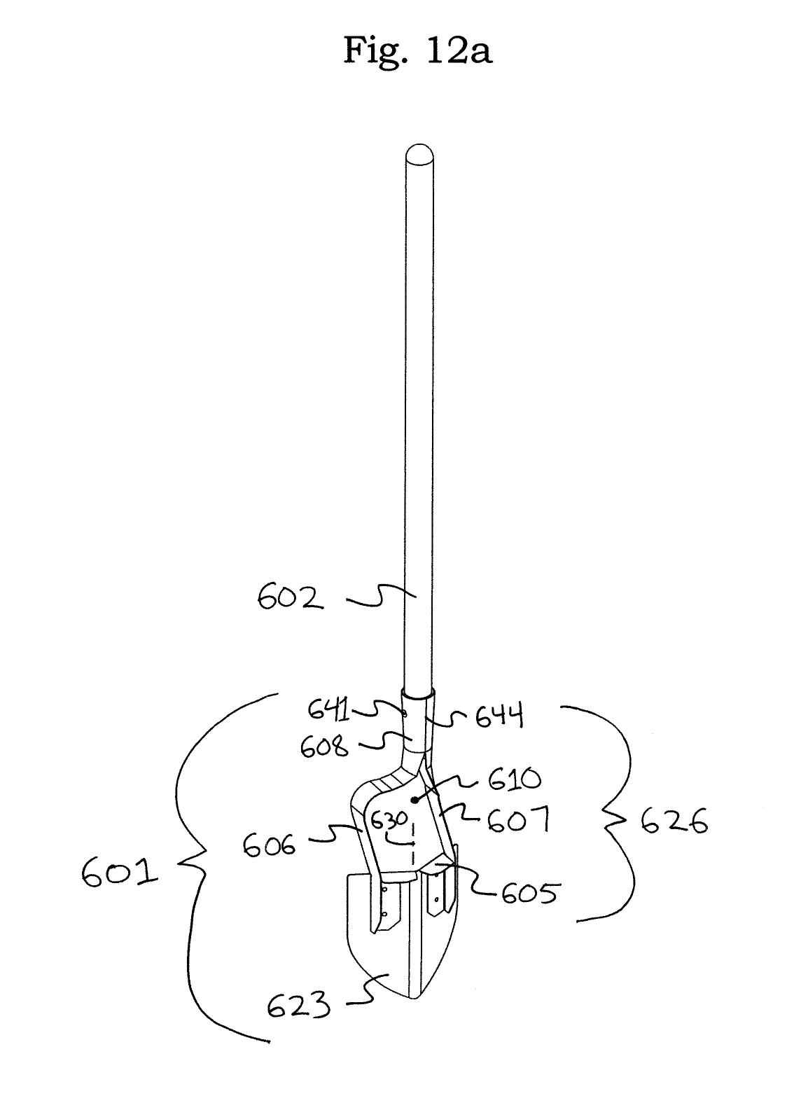

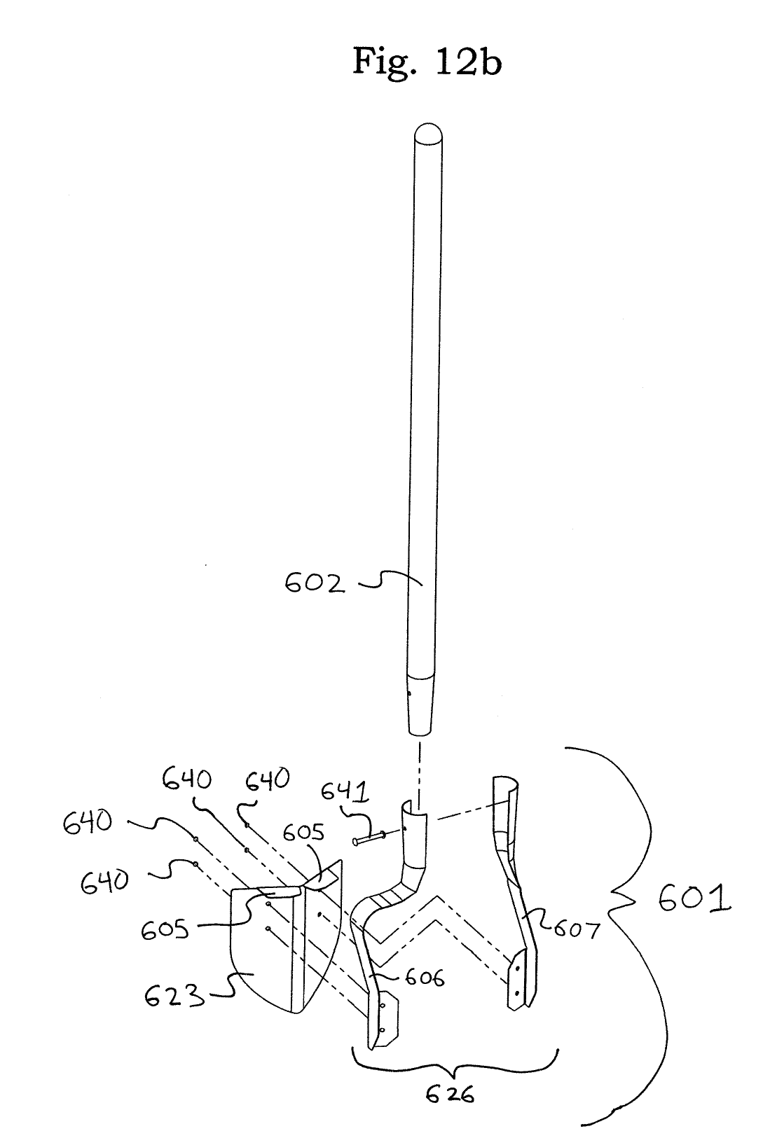

FIG. 12a illustrates a different shovel embodiment. A shovel head 601 comprises a blade 623 and a bifurcated shaft support 626, which is attached to a shaft 602 at a socket 608 via a rivet 641 or other means. Bifurcated shaft support 626 has a left support 606 and a right support 607, which are joined together at socket 608. The strength of bifurcated shaft support 626 is increased by welding the left support 606 and right support 607 together along a weld line 644. Bifurcated shaft support 626 creates an aperture 610 that leaves unimpeded access to one or more central step 605 surfaces. Socket 608 and shaft 602 are offset from the shovel head centerline 630 to accommodate unimpeded movement of the leg and knee of the user.

FIG. 12b, an exploded view of the embodiment shown in FIG. 12a, further depicts the composition of head 601. Blade 623 is fastened to bifurcated shaft support 626 by means of welds, rivets, threaded fasteners, or other means that are obvious to persons skilled in the field. Rivets 640 are shown here.

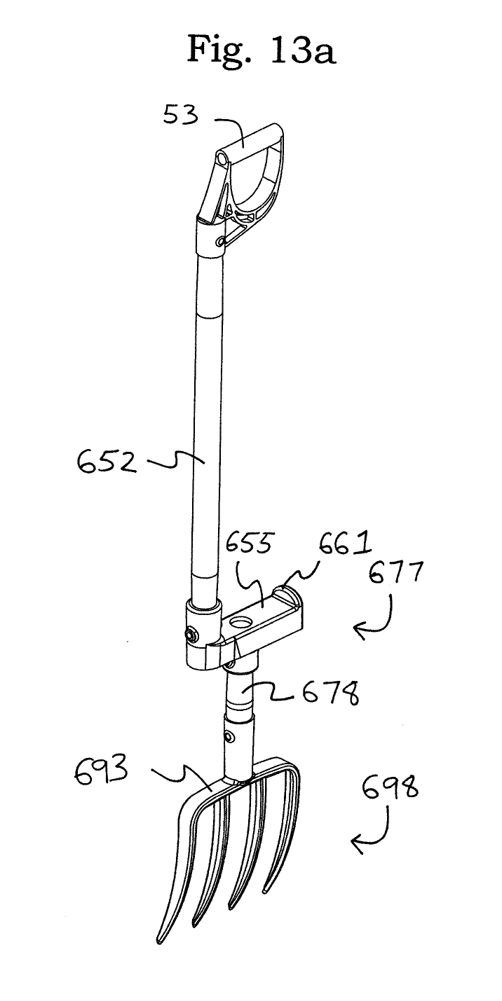

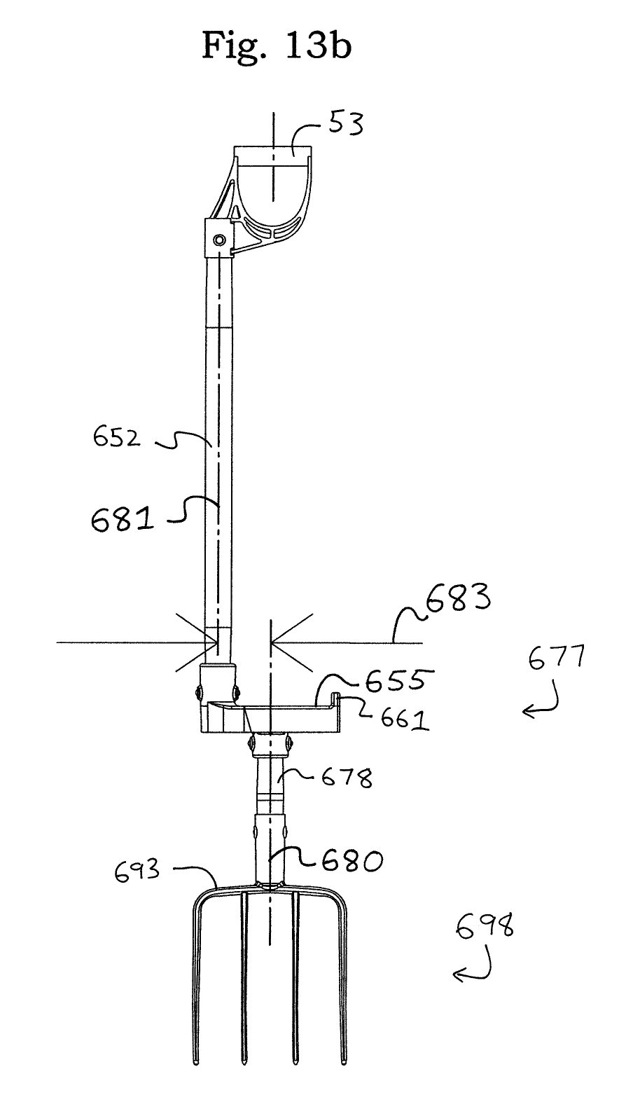

FIG. 13a shows an embodiment in which a conventional spading fork head 698 is attached to an adapter 677 via an adapter shaft 678. Adapter 677 supports a shaft 652 and provides a central step 655. Adapter 677 may incorporate a guide 661 to prevent the user's foot from sliding off the step during use. Central step adapter 677 may be molded or cast plastic, or other suitable material. In this embodiment, central step surface 655 is higher than the customary position of the foot directly above the tines on a cross bar 693. This feature enables the user to push cross bar 693 below the soil surface, enabling the user to readily loosen soil deeper than would be possible with an ordinary spading fork. The process of double digging, used extensively in biodynamic gardening, can be simplified with the use of a tool such as this one.

FIG. 13b, the rear elevational view of the embodiment shown in FIG. 13a, shows an offset 683 of a shaft centerline 681 from a tool head centerline 680, and the unimpeded access to central step surface 655 provided by this design.

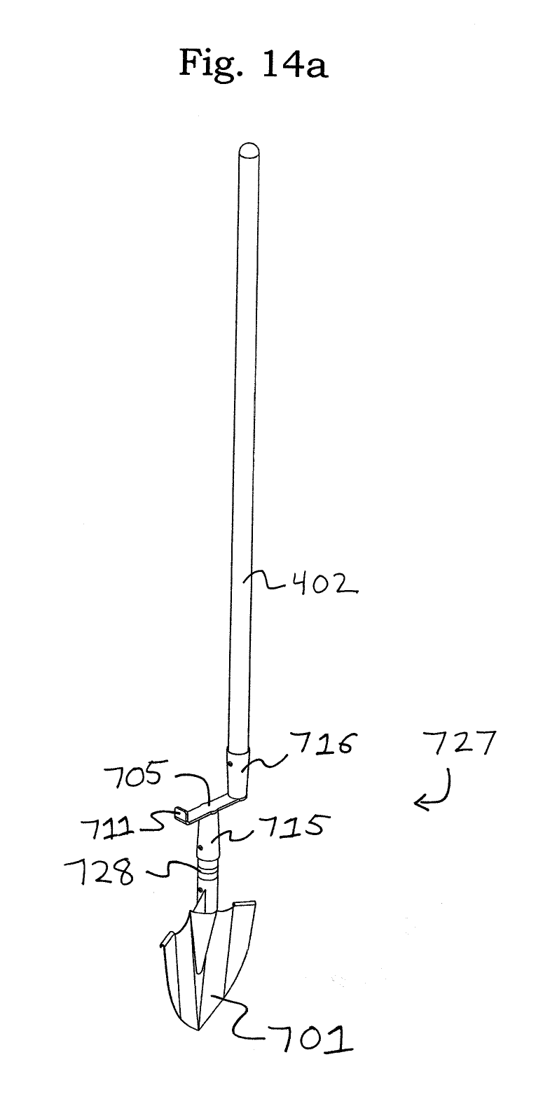

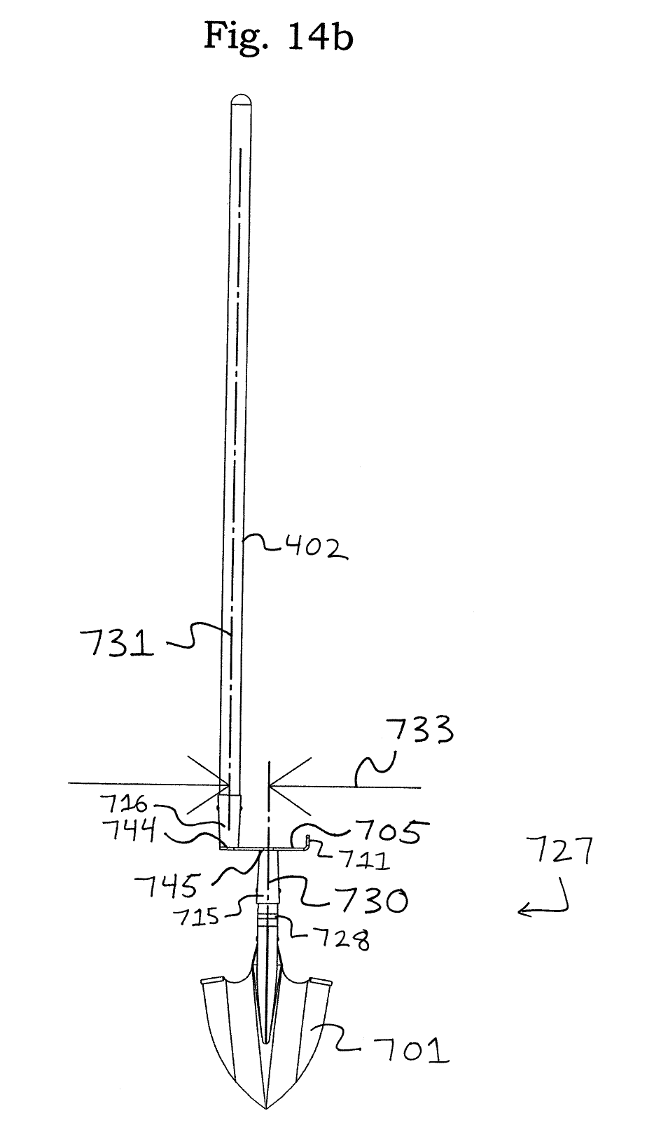

FIG. 14a shows an embodiment of an adapter as applied to a shovel. A conventional shovel head 701 is connected to an adapter 727 via an adapter shaft 728. In this particular embodiment, adapter 727 comprises an upper socket 716 and a lower socket 715 that are made of formed and welded sheet steel, and then welded to a central step plate 705, or other suitable manufacture. Central step plate 705 may have a guide 711 to keep the user's foot from sliding off. Adapter 727 is higher than the customary position of the foot directly atop shovel head 701. This enables the user to readily dig deeper holes such as for the placement of fence posts or planting of trees.

FIG. 14b, the rear elevational view of the embodiment shown in FIG. 14a, shows an offset 733 of a shaft centerline 731 from a shovel head centerline 730, and the unimpeded access to central step plate 705 provided by this design. Furthermore, as was described briefly above, the adapter 727 is welded, and FIG. 14b portrays weld lines 744 and 745 to detail the construction of adapter 727.

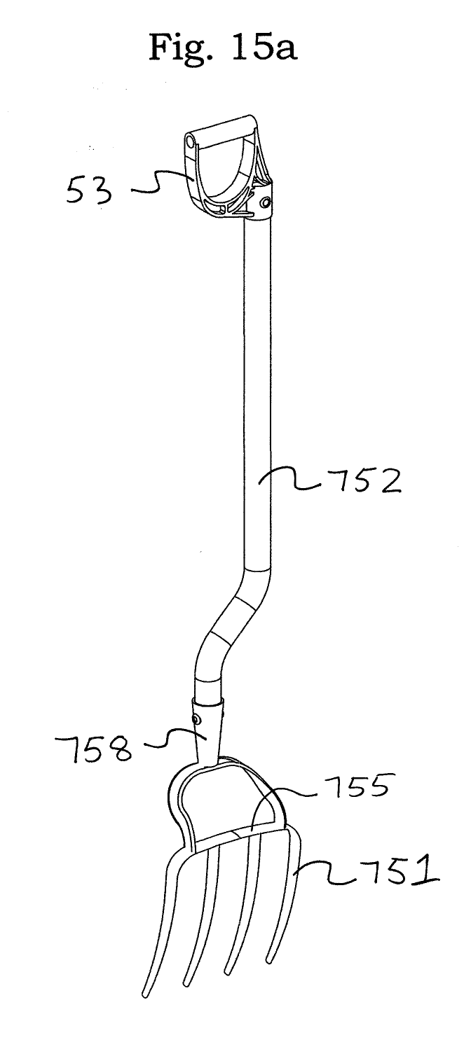

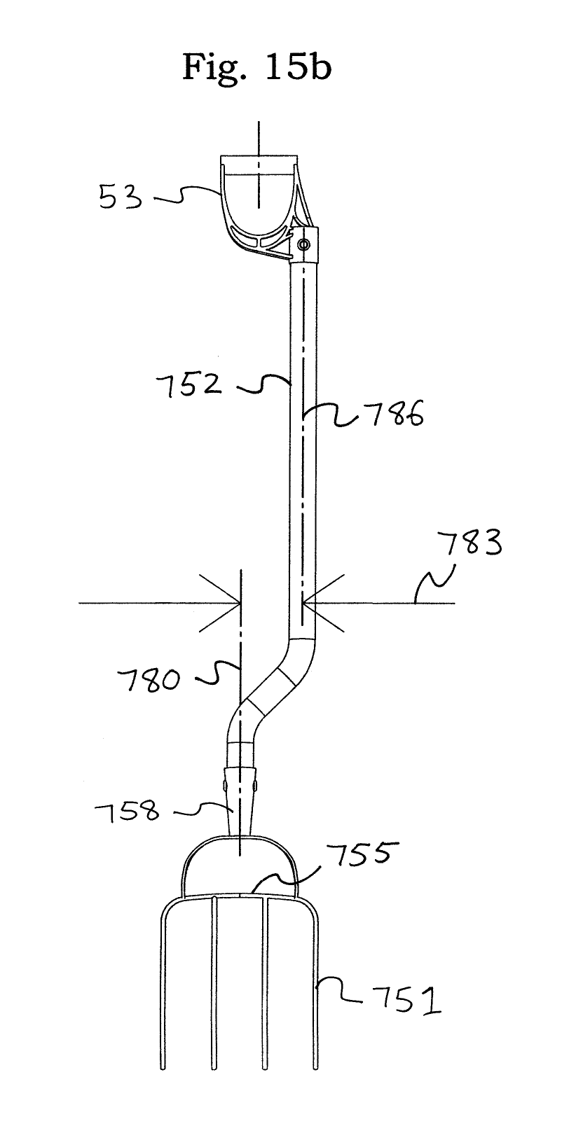

FIG. 15a shows an embodiment in which a tool head 751 is produced in accordance with U.S. Pat. No. 3,226,149 to McJohnson (1965), but then attached to an offset shaft 752 that is offset to allow clearance to the knee and leg of the user. A socket 758 and lowest part of offset shaft 752 may still possibly interfere with the lower leg of the user, but improved efficiency is realized by replacing the original straight shaft with offset shaft 752 shown here. In this example, offset handle 53 places the center of the grip surface in line with the tool centerline, but a variety of handles could be used. Tool head 751 may be a spading fork or a shovel.

FIG. 15b shows an offset 783 of an upper shaft centerline 786 from a tool head centerline 780 that allows the user to apply forces to a central step 755 with reduced interference between the leg and knee of the user and shaft 752.

The tool heads of the above embodiments could be fabricated from a multitude of elements made of a variety of materials. The descriptions herein of possible materials and fabrication methods of the tool head are not meant to exclude materials and methods not described. In addition, embodiments depicted herein with a spading fork head also function with a shovel blade, and vice versa.

The shafts of the above embodiments may be produced by a variety of means from a variety of materials. Shafts may be made from wood, metal, composite materials such as fiberglass, or glass-filled polymers such as glass-reinforced nylon. The descriptions herein of possible materials and fabrication methods of the shafts are not meant to exclude materials and methods not described.

The handles of the above embodiments may be produced by a variety of means from a variety of materials. Handles may be made out of a wide variety of materials, or may be made as a single piece of metal, plastic or other suitable material. The descriptions herein of possible materials and fabrication methods of the handle are not meant to exclude materials and methods not described.

Lastly, it should be noted that the division of the tools described herein into three distinct parts (head, shaft, and handle) is meant primarily to add clarity to the descriptions. The functions of the parts described may be performed by any number of components, numbering from one in the case of a single piece tool, to a multitude of tines insert-molded into a fiber-reinforced plastic body.

### Operation

The manner of using the spading fork shown in FIG. 1a is identical to that for spading forks in present use. Tines 54 are driven into the soil by force applied by the user at central step 55. The alignment of central step 55 with tool head centerline 80, best seen in FIG. 1b, minimizes the tendency of the tool to rotate to either the left or right. The insertion forces are minimized by the small cross-section of tines 54, shown in FIG. 2a, which resist bending due to normal tilling loads or side loads generated during soil penetration. After the tines are driven into the soil, pulling backwards on handle 53 loosens the soil. During this operation, it is often desirable to have handle centerline 82 aligned to tool head centerline 80, and so the use of offset handle 53 is advantageous. Left support 56, right support 57 and horizontal section 59 form aperture 60 that provides unobstructed access to central step 55. Horizontal section 59 may be used to lift the tool out of the soil during use, reducing the effort expended by the arms of the user. The manner of using a spading fork shown in FIG. 6a is identical to that of the spading fork shown in FIG. 1 a.

The manner of using a spading fork shown in FIG. 3a is nearly identical to that of the spading fork shown in FIG. 1a. Central step 155 is unobstructed by shaft 52, but the user must lift the tool by handle 53 to position the tool during use without the option of lifting the tool with the foot of the user. The manner of using a spading fork as shown in FIG. 4a or FIG. 15a is identical to that of the spading fork shown in FIG. 3a.

The manner of using a spading fork shown in FIG. 7a is nearly identical to that of the spading fork shown in FIG. 1a. Symmetric handle bar 372 is gripped by both hands of the user to pull back while loosening the soil. This enables users with less upper-body strength to till garden beds. In some cases, a user may lift soil with the spading fork and bounce the soil on the tines to break up a clump of soil. It is desirable to minimize the tendency of the tool to rotate in the hands of the user, and so the outboard handle position of L-shaped handle 525 shown in FIG. 11 has the benefit of aligning the forces of the soil, lifting hand, and balance hand.

The spading fork shown in FIG. 5a is designed to be used in the manner of a conventional spading fork, as well as to loosen soil deeper than a conventional spading fork. Double-digging is a common practice in Biodynamic gardening in which a layer of soil is loosened with a spading fork and removed with a shovel. The next-lower layer of soil is loosened with a spading fork and the top layer of soil is returned. This labor-intensive technique is used to maximize garden productivity, but requires large expenditures of energy. Similar loosening of the soil to a comparable depth can be achieved with the use of the spading fork shown in FIG. 5a. The soil is loosened to the depth of the tines by driving tool head 251 into the soil to the point where lower central step 267 is flush with the soil surface, at which point handle 53 is pulled back towards the user to loosen the top layer of soil. After the top layer of soil is loosened, tool head 251 can be driven into the soil until upper central step 268 is flush with the soil surface. Pulling back on handle 53 then loosens the next layer of soil. The spading fork shown in FIG. 13a is designed to be used in the manner of a conventional spading fork, as well as being designed to loosen soil deeper than a conventional spading fork in the manner of the spading fork shown in FIG. 5a.

The manner of using the shovel shown in FIGS. 8a and 8b is identical to that for trenching shovels in present use. The user applies force by the foot to central step 405 to drive blade 423 into the soil. The alignment of central step 405 to tool head centerline 430 minimizes the tendency of the tool to rotate sideways, or for the foot to slip off the shovel blade. Furthermore, offset 433 of shaft centerline 431 from blade centerline 430 minimizes interference between the knee and leg of the user with shaft 402.

The manner of using the shovel shown in FIGS. 9a and 9b is identical to that for shovels in present use. The user applies force by the foot to central step 455 to drive blade 473 into the soil. The alignment of central step 455 to tool head centerline 480 minimizes the tendency of the tool to rotate sideways. The tendency of the foot to slip off the shovel blade is minimized by socket 458 and guide 461 on either side of central step 455.

The manner of using the shovel shown in FIGS. 10a and 10b is identical to that for shovels in present use. The user applies force by the foot to central step 405 to drive blade 423 into the soil. After pulling back on shaft 502 or L-shaped handle 525, the soil is loosened. While lifting and transporting soil, the user may hold shaft 502 near socket 408 and grip 522 of L-shaped handle 525 in order to balance any twisting forces created by offset 533 between shaft centerline 531 and blade centerline 430.

The manner of using the shovel shown in FIG. 12a is identical to that for shovels in present use. The user applies force by the foot to central step 605 to drive blade 623 into the soil. After pulling back on shaft 602, the soil is loosened and removed. The alignment of central step 605 to shovel centerline 630 reduces the tendency of the blade 623 to rotate to the right or left while being driven into the soil, and the offset of shaft 602 from the blade centerline 630 allows the user to apply force to the central step without interference between the knee and leg of the user with shaft 602.

The manner of using the shovel shown in FIG. 14a is identical to that for shovels in present use. The increased height of central step 705 above blade 701 makes it an ideal tool for digging deep holes, such as for fence posts.

The manner of using all of the spading forks and shovels described above is identical to that for tools in present use. In all cases, the tool is used with maximum efficiency, with the tool driven into the soil with forces applied directly through the centerline of the tool head, while the shaft and handle remain clear of the knee and leg of the user.

As can be appreciated from the description above, the digging and tilling implements of the various embodiments of the invention allow the user to leverage body strength more effectively and without wasted effort by providing a central step, by having adequate clearance between the shaft and the knee and leg of the user, and by providing a handle in an ergonomically balanced position for the user. In addition, the spading fork tine described above provides a tool head with increased durability and better performance.

While the invention has been described with respect to certain embodiments, the description is intended to be exemplary, rather than limiting. Modifications and changes may be made within the scope of the invention. For example, the tool head could be something other than a fork or shovel, the shaft can provide clearance in a variety of ways, and the implement could be any tool that requires foot pressure. The scope of the invention is set forth in the appended claims.

What is claimed is:

1. A digging or tilling tool, comprising:
a tool head having a generally vertically extending centerline;
an elongate shaft coupled to the tool head at a position horizontally offset from the centerline of the tool head; and
a first, generally horizontal platform or step essentially centered on the centerline of the tool head, such that force applied to the platform or step is transmitted to the tool head.

2. The digging or tilling tool of claim 1, further comprising a handle attached to the shaft at or near an end of the shaft opposite the tool head.

3. The digging or tilling tool of claim 2, wherein a centerline of the handle is offset from a centerline of the shaft such that it is substantially aligned with the centerline of the tool head.

4. The digging or tilling tool of claim 2, wherein a centerline of the handle is offset from a centerline of the shaft in a direction opposite the centerline of the tool head.

5. The digging or tilling tool of claim 1, wherein the shaft is attached to the tool head by attachment parts comprising:
a first engaging structure (1) being adapted to engage a second, complementary engaging structure on or attached to the shaft so as to couple the shaft to the tool head, and (2) being situated at the point horizontally offset from the centerline of the tool head; and
a first and second connecting members connected between the first engaging structure and the tool head, the first and second connecting members being horizontally spaced from one another so as to leave an opening therebetween, the first and second connecting members connecting to the tool head proximate to side edges thereof, such that the opening is bounded by the first and second connecting members and is located over the first platform or step.

6. The digging or tilling tool of claim 5, wherein the first engaging structure is a socket.

7. The digging or tilling tool of claim 5, wherein the first engaging structure is a spike.

8. The digging or tilling tool of claim 5, further comprising:
a second platform or step connected between the first and second connecting members, the second platform or step being positioned above the first platform or step.

9. The digging or tilling tool of claim 8, wherein the second platform or step includes an upward projection that serves as a foot guide.

10. The digging or tilling tool of claim 5, wherein the head is rearwardly offset relative to a centerline of the shaft.

11. The digging or tilling tool of claim 1, wherein the head is rearwardly offset relative to a centerline of the shaft.

12. The digging or tilling tool of claim 1, wherein the first platform or step includes an upward projection that serves as a foot guide.

13. The digging or tilling tool of claim 1, wherein the tool is a spade.

14. The digging or tilling tool of claim 1, wherein the tool is a fork with two or more tines.

15. The digging or tilling tool of claim 14, wherein the two or more tines have a generally L-shaped cross-section.

16. The digging or tilling tool of claim 14, wherein the two or more tines have a generally T-shaped cross-section.

17. A digging or tilling tool head, comprising:
a first member; and
a plurality of depending tines connected to one side of the first member so as to extend in a direction generally perpendicular to the extent of the first member, each of the plurality of tines being spaced from one another, and each of the plurality of tines having an L-shaped or T-shaped cross section;
wherein the tool head has a generally vertically-extending centerline.

18. The digging or tilling tool head of claim 17, further comprising a first engaging structure connected to or formed integrally with the first member on a second side of the first member.

19. The digging or tilling tool head of claim 18, wherein the first engaging structure is positioned proximate to one end of the first member, horizontally offset from the centerline of the tool head.

20. The digging or tilling tool head of claim 17, further comprising:
a first engaging structure (1) being adapted to engage a second, complementary engaging structure on or attached to a shaft so as to couple the shaft to the tool head, and (2) being situated at a point horizontally offset from the centerline of the tool head; and
a first and second connecting members connected between the first engaging structure and the first member, the first and second connecting members being horizontally spaced from one another so as to leave an opening therebetween, the first and second connecting members connecting to the first member proximate to side edges thereof, such that an opening is provided over the first member, bounded by the first and second connecting members.
